(19) United States
(12) Patent Application Publication
(10) Pub. No.: US 2002/0101976 A1
(43) Pub. Date: Aug. 1, 2002

(54) Method and system for installing and activating telephone equipment

(76) Inventor: John A. Doucette, Londonderry, NH (US)

Correspondence Address: ELMER GALBI, 13314 VERMEER DRIVE, LAKE OSWEGO, OR, 97035

(21) Appl. No.: 09/774,786

(22) Filed: Jan. 30, 2001

(51) Int. Cl. H04M 7/00

(52) U.S. Cl. 379/231; 379/234

(57) ABSTRACT

A telephone system which has the ability to detect when a handset is connected to a local loop telephone line. The system does not allocate any significant amount of resources to handle calls on a particular local loop until it detects that a handset is connected to the local loop line. When the system is installed in a wiring closet the lines to each of the local loops in the building or office suite can be connected to the system. When handsets are connected to particular local loops, the system allocates resources to the particular local loop.

### FIELD OF THE INVENTION

The present invention relates to telephone equipment and more particularly to the installation and activation of telephone equipment.

### BACKGROUND OF THE INVENTION

U.S. Pat. No. 6,108,346 which was issued Aug. 22, 2000 and co-pending patent application Ser. No. 09/527,968 filed Mar. 17, 2000 entitled “Integrated Scalable PBX and Router with Pooling” describe an integrated system that provides the functions of both a telephone PBX and an Ethernet data router. The system shown in the above cited references has both ports that provide connect to local loop telephone lines and ports that connect to Ethernet cables.

Telephone systems and routers for Ethernet cables are typically installed in a building's of office suite's wiring closet. In many instances at least two unshielded twisted pairs of wires (UTP) cables (i.e. a telephone cable and an Ethernet cable) extend from the wiring closet to each office in the building or office suite. An office typically includes a computer connected to the Ethernet cable and a telephone is connected to the telephone cable.

The Ethernet protocol has a facility whereby units connected to an Ethernet LAN can notify other units on the LAN of their presence. Thus if one end of an Ethernet cable is connected to a router, when a computer is connected to the other end of the cable, the computer will notify the router of its presence on the LAN. A router need not allocate any significant amount of resources to handle a particular port until the router is notified that a unit is connected to that port. It is wasteful to assign resources to a port when no devices are connected to that port.

### SUMMARY OF THE PRESENT INVENTION

The present invention provides a telephone system which has the ability to detect when a handset is connected to a local loop telephone line. The system does not allocate any significant amount of resources to handle calls on a particular local loop until it detects that a handset is connected to the local loop line. When the system is installed in a wiring closet the lines to each of the local loops in the building or office suite can be connected to the system. When handsets are connected to particular local loops, the system allocates resources to the particular local loop.

### BRIEF DESCRIPTION OF THE FIGURES

FIG. 1 illustrates an office suite with a wiring closet and lines going from the wiring closet to the offices.

FIG. 2 illustrates a system that has resources that are allocated to handle calls on local loop lines.

FIG. 3 is a circuit for detecting if a handset is connected to a local loop.

FIG. 4 is a flow diagram of the operation of the invention.

### DETAILED DESCRIPTION

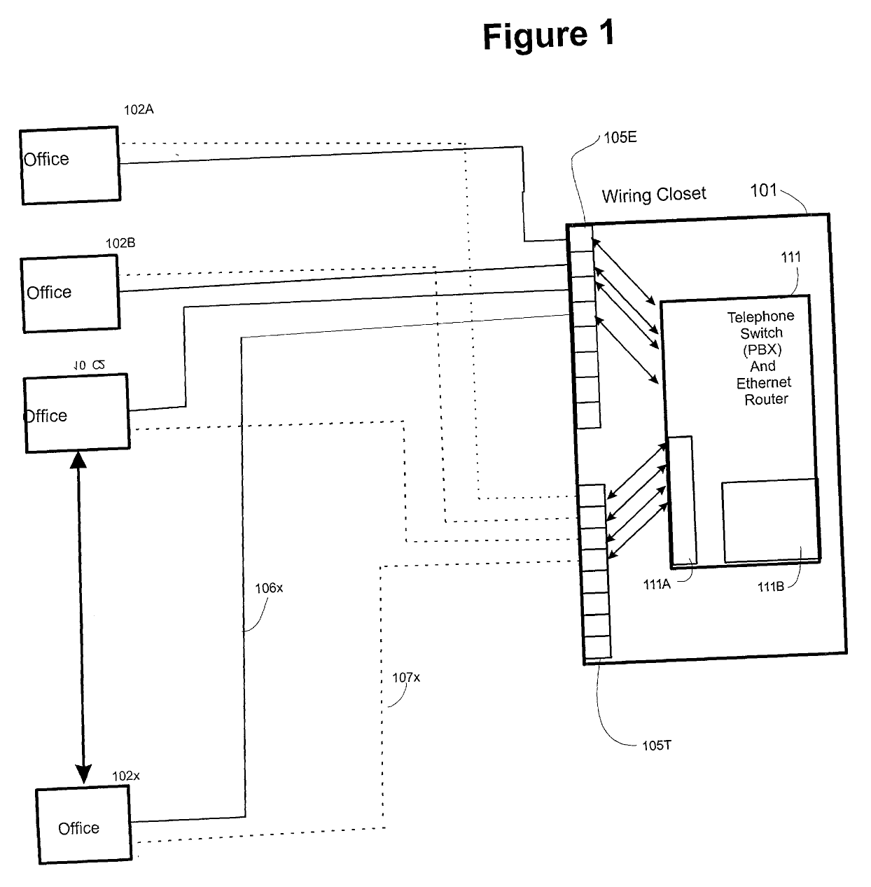

A typical office suite 100 is illustrated in FIG. 1. The suite includes a conventional wiring closet 101 and offices 102A to 102x. The arrow between offices 102C and 102x indicates that there can be any number of offices as appropriate for a particular office suite. It is noted that in FIG. 1, the physical size of the offices 102A to 102x relatives to the size of the wiring closet 101 is not to scale. The actual size of the offices and the wiring closet is as is conventional.

There is an Ethernet cable (for example 106x shown by the solid line) and a telephone cable (for example 107x shown by the dotted line) between each office and the wiring closet 101. The lines from wiring cabinet 101 to offices 102A to 102x are designated 107A to 107x. All of the lines are collectively referred to as lines 107. Each of these lines is a conventional UTP (unshielded twisted pair) cable. Each telephone cable has two physical wires and each Ethernet cable has four physical wires. Thus, there is both a LAN (local area network) connection and a conventional telephone connection between the wiring closet and each office 102A to 102x. It is noted that there may be other connections to the wiring cabinet 101 such as lines the outside telephone network and to various outside computer networks. These are not shown in FIG. 1 since they are not particularly relevant to the present invention.

A combined telephone switch and Ethernet router 111 is located in wiring closet 101. The combined telephone switch and Ethernet router 111 may be the type of unit shown in U.S. Pat. No. 6,108,346 which was issued Aug, 22, 2000 or in co-pending patent application Ser. No. 09/527,968 filed Mar. 17, 2000 entitled “Integrated Scalable PBX and Router with Pooling”. This application and patent here hereby incorporated herein by reference.

The telephone lines from offices 102A to 102x are terminated at posts on terminal block 105T located in wiring closet 101. The Ethernet lines from offices 102Ato 102x are terminated at posts on a terminal block 105E located in wiring closet 101. (It is noted that the posts on terminal blocks 105E and 105T are not specifically shown in the drawings). Terminal blocks 105E and 105T are conventional commercially available terminal blocks. All the post on the terminal blocks 105T and 105E are connected to the combined telephone switch and Ethernet router 111.

Some of the lines 107 have telephone handsets connected to them in offices 102A to 102x. Other offices do not have handsets connected to line 107 that goes to that particular office. As explained below, the present invention provides a mechanism whereby telephone switch and Ethernet router 111 can detect which offices have telephone handsets connected to line 107 that goes to the office and which offices do not have handsets connected to line 107 connected to that office. Each of the lines 107 which has a telephone handset connected to it utilizes some resources 111B in telephone switch and Ethernet router 111. Resource 111B could for example be memory which must be allocated to handle calls on a particular line. Allocation of resources to service particular lines is conventional in computerized PBX systems. As an extreme example, if none of the offices 102A to 102x have telephone handsets connected to lines 107, the telephone switch and Ethernet router 111 would have to allocate none of the resource 111B to handling calls on the telephone lines and this resource could be assigned to other tasks such as handling Ethernet packets.

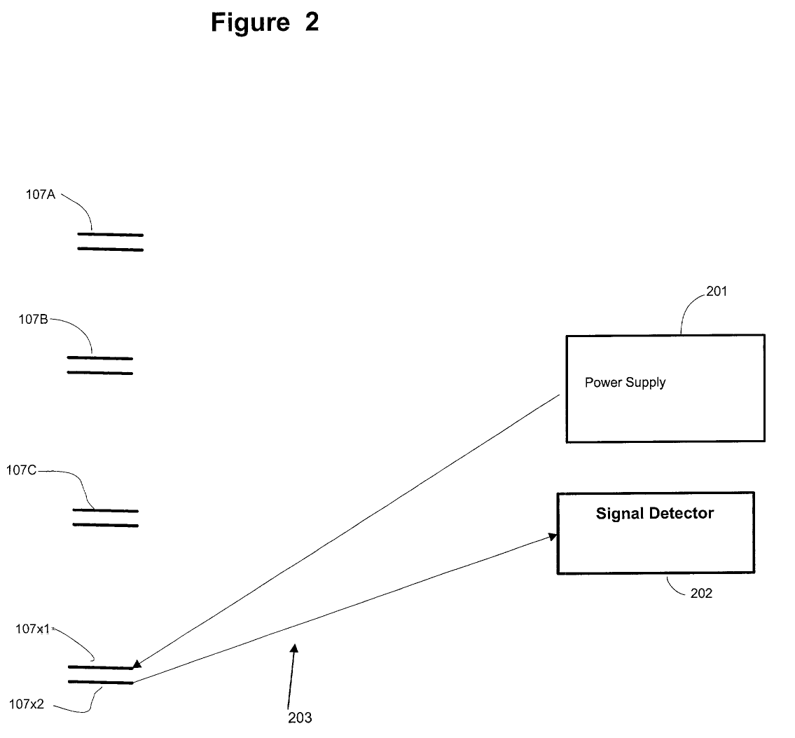

A presence detection circuit 111A interfaces the lines from terminal block 105T to telephone switch and Ethernet router 111. The present detector circuit 11A is shown in more detail in FIG. 2. It should be understood that each of the Ethernet cables 106 consists of four physical wires and each of the telephone cables 107 consist of two physical wires. In FIG. 2 these two wires in a representative telephone cable are designated 107×1 and 107×2. The presence detector consists of a power supply 201, a signal detector 202 and a switch 203. The power supply 201 and the current detector 202 are periodically connected to each pair of telephone lines 107.

The power supply applies an AC voltage to the lines and if the signal detector detects the AC signal it indicates that a telephone handset is connected to the other end of the lines. As an example, an AC voltage in the range of 5 to 10 volts and 1000 cycles per second could be used. Note that when a handset is connected to telephone lines, the ring circuit provides a path for an AC signal. If a handset is not connected to the lines, there is an open circuit and no current can flow. If the signal detector 202 determines that there is a telephone connected to the line, resources 111B are allocated to that particular line. A conventional switch 203 (not explicitly shown in FIG. 2) sequentially connects the power supply 201 and the current sensor 202 to each of the telephone lines 107A to 107x in sequence.

If the present detector 111A detects that there is telephone handset connected to a particular line 107, a portion of resource 111B is allocated to this particular line 107. The resources allocated could, for example, be some memory that is allocated to handling calls to and from this line.

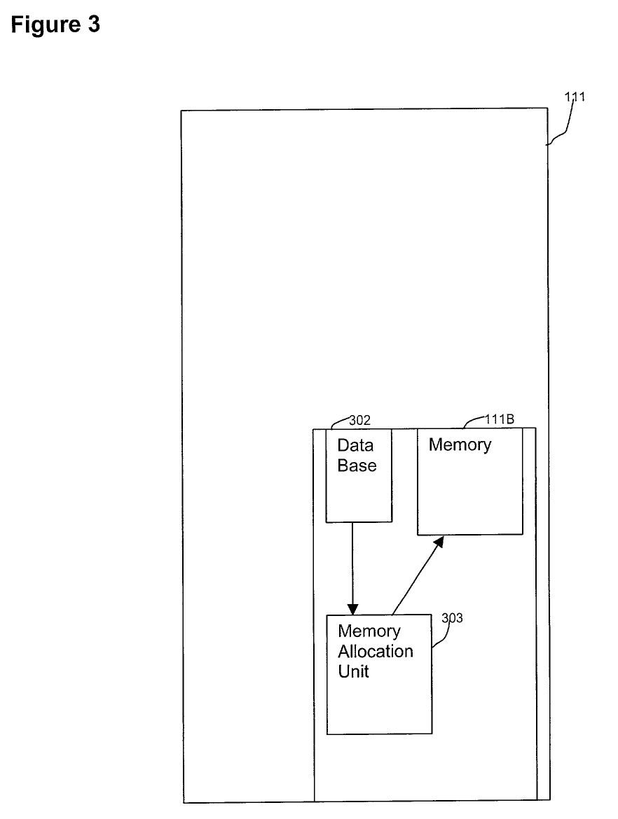

FIG. 3 illustrates the portion of system 111 that allocates resources to handle calls. Memory 111B provides memory for many function in system 111. For example it provides memory for the operating system and it provides memory that is uses to service each of the active telephone lines connected to the system. Data base 302 contains information indicating which telephone lines have handsets connected to the lines. Data base 302 is updated by the presence detector 111A. Memory allocation Unit 303 allocates a portion of memory 111B to each telephone line which has a handset connected thereto. Among other functions the memory allocated to each line serves as a memory buffer for data from the associated line.

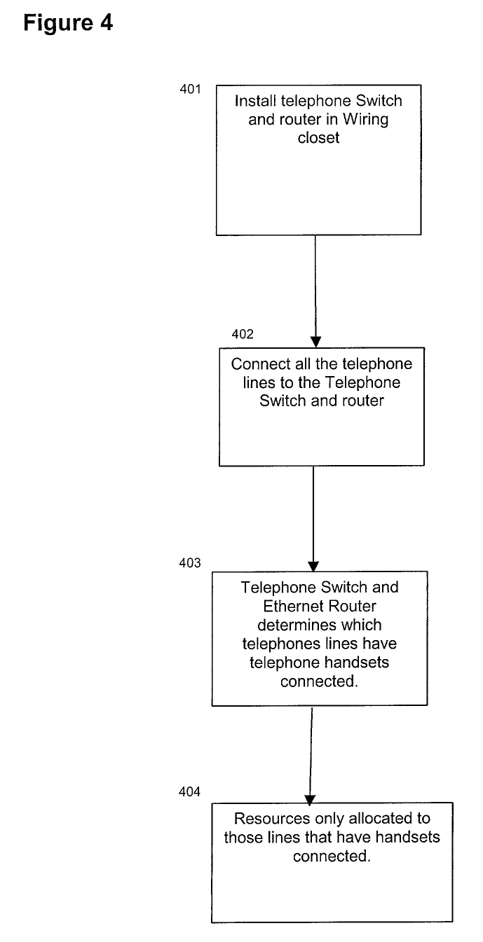

The present invention greatly facilitates installing a telephone and Ethernet switch in a suite of offices. FIG. 4 illustrates the process of the present invention. First, as indicated by block 401, the Telephone Switch and Ethernet router 111 is installed in the wiring closet 101. Next as indicated by block 402 all the lines on terminal blocks 105E and 105T are connected to the unit 111. The Telephone Switch 111 then detects which lines 107 have handsets connected to them as indicaterd by block 403. For those lines that do have handsets connected, and only for those lines, a portion of resource 111B is allocated as indicated by block 404.

The result is that only those lines with handsets utilize a portion of resource 111B. Thus, the technician installing unit 111 need not spend time determining which lines have handsets connected. The technician merely connects all of the telephone lines to unit 111 and unit 11 detects and allocates resources to those lines that have handsets connected to them.

The present invention also facilitates identifying telephone lines which are defective. If a technician knows that a hand set is connected to a particular pair of lines and the system shows no handset connected, it indicates that the lines are defective.

It is noted that the Telephone Switch and Ethernet router 11 uses the inherent properties of an Ethernet protocol to determine which Ethernet lines have computers connected thereto. Resources are only allocated to those Ethernet lines that have computers connected thereto. While the embodiment of the invention described above utilizes a combined Telephone Switch and Ethernet router, the invention could also be applied to a standalone telephone PBX.

While a preferred embodiment of the invention has been shown and described, it should be understood that various changes in form and detail can be made without departing from the spirit and scope of the invention. The scope of the invention is limited only by the scope of the appended claims.

I claim:

1) a method of installing telephone equipment, said telephone equipment comprising a telephone switching unit adapted to be connected to a plurality of telephone lines, some of said telephone lines having handsets connected thereto, the lines which have telephone handsets connected thereto requiring resources in said telephone switching equipment, comprising
installing said telephone switching unit in a wiring closet
connecting all of the of said telephone lines to said telephone switching unit,
determining which lines have handsets connected thereto,
allocating resources to only those lines which have handsets connected thereto,
whereby technician time can be saved since all of the lines are connected without previously testing to see which lines have handsets connected thereto.

2) The method recited in claim 1 one wherein said technician also determines problems with specific telephone lines by noting lines which have no resources allocated thereto and which are known to have hand sets connected thereto.

3) The method recited in claim 1 wherein said telephone switching unit includes a presence detector to determine which lines have handsets connected thereto.

4) The method recited in claim 3 wherein said presence detector includes a power supply and a switch which sequentially applies a 1000 cycles per second AC voltage to each of the telephone lines.

5) The method recited in claim 4 wherein said presence detector includes a AC signal detection circuit.

6) A telephone PBX (private branch exchange) for switching telephone calls for a plurality of telephone lines, said telephone PBX including a handset presence detector, said presence detector including an AC power supply, an AC current sensor and a switch, said power supply and said current sensor being sequentially connected to all of said telephone lines to determine which lines have handsets connected thereto, said telephone PBX assigning certain resources to only those lines that have telephone handsets connected thereto.

7) A switching system which includes,
servicing means for servicing a plurality of telephone lines connected to said switching,
said servicing means including means for allocating resources to telephone lines in order to service said lines,
means for detecting which of said telephone lines have handsets connected thereto,
said servicing means including means for only allocating resources to the lines which said detecting means indicates have handsets connected thereto.

8) The system recited in claim 7 wherein said means for detecting includes an AC power supply and a signal sensing circuit which are sequentially connected to said lines.

9) The system recited in claim 7 including means for routing Ethernet packets.

10) A method of installing a combined Ethernet router and telephone switch, said combined unit including a telephone switching unit adapted to be connected to a plurality of telephone lines, some of said telephone lines having handsets connected thereto, the lines which have telephone handsets connected thereto requiring resources in said telephone switching equipment, comprising
installing said telephone switching unit in a wiring closet
connecting all of the of said telephone lines to said telephone switching unit,
determining which lines have handsets connected thereto,
allocating resources to only those lines which have handsets connected thereto,
whereby technician time can be saved since all of the lines are connected without previously testing to see which lines have handsets connected thereto.

11) The method recited in claim 10 wherein said method includes connecting a plurality of Ethernet cables to said combined unit, said unit including means for detecting which Ethernet cables have computer equipment connected thereto.
